(19) United States
(12) Patent Application Publication
(10) Pub. No.: US 2025/0230594 A1
(43) Pub. Date: Jul. 17, 2025

(54) Clothes washing device powered by a handheld drill

(71) Applicant: SUNGHOON SAMUEL OH, HARBOR CITY, CA (US)

(72) Inventor: SUNGHOON SAMUEL OH, HARBOR CITY, CA (US)

(21) Appl. No.: 18/952,408

(22) Filed: Nov. 19, 2024

Related U.S. Application Data
(60) Provisional application No. 63/682,454, filed on Aug. 13, 2024.

(51) Int. Cl. D06F 13/02; B25F 3/00

(52) U.S. Cl. CPC D06F 13/02; B25F 3/00

(57) ABSTRACT

A clothes washing device built on a bucket lid includes a hexagonal shaft, rotor, oscillator, ball bearings, link and agitator. The rotor and oscillator are inserted into the ball bearings and held by a mount. The hexagonal shaft fixed on the rotor is inserted into a keyless chuck of an electric handheld drill and is rotated automatically. Rotary motion of the rotor is converted to oscillatory motion of the oscillator by the link moving back and forth through its range of linear motion. The oscillatory motion is transmitted to the agitator and washes clothes in the bucket automatically.

### CROSS-REFERENCE TO RELATED APPLICATIONS

This application claims priority from U.S. Provisional Application No. 63/682,454 filed on Aug. 13, 2024, the entirety of which is hereby fully incorporated by reference herein.

### STATEMENT REGARDING FEDERALLY SPONSORED RESEARCH OR DEVELOPMENT (IF APPLICABLE)

Not Applicable

### REFERENCE TO A SEQUENCE LISTING, A LARGE TABLE, OR A COMPUTER PROGRAM LISTING APPENDIX ON READ-ONLY OPTICAL DISC (IF APPLICABLE)

Not Applicable

### BACKGROUND

### Field

Most people do not like using public laundry facilities in general, since it is inconvenient and more time-consuming compared to doing laundry right at their residence. Not only is the whole experience troublesome, but it is also frustrating to wait for a washing machine to become available. It is the most frustrating experience to find available machines with clothes still left inside, and the owner is nowhere to be found.

Individuals who camp out or live in their own vehicles, as well as those who live in apartments without in-unit washers. are always looking for alternative ways to wash their clothes outside communal laundry facilities. In another aspect, even if a residence has a full-size washer, using a separate washer for dirty rags or work clothes is also desired. Also, sometimes there is a need to wash a single clothing item, but it is not cost-effective to run a full-size washer just for one item.

### Description of the Related Art

To meet consumer needs, there are portable clothes washing devices available that attach to a bucket, sink, or bath tub as well as standalone mini-washers, although they can be quite expensive. Some portable clothes washing devices are manually operated, but most people prefer to use electrically powered devices to save effort and time. However, based on online sales reviews, many of these portable clothes washing devices suffer from limited life cycles due to electrical or electronic components that burn out prematurely. Also, many of the gadgets that work as attachments often lack durability or simply don't have enough agitation power to wash clothes properly.

For the aforementioned reasons, people often wind up washing their clothes by hand instead of using the portable clothes washing devices they purchased when going to a laundromat is not an option. Without compromising the portability and affordability that customers have come to enjoy, the portable clothes washing devices that are currently available in the market need to improve dependability and performance.

### BRIEF SUMMARY

Described herein is a clothes washing device that is portable and unique in the way of being operated automatically. The clothes washing device utilizes a widely available bucket lid as a platform to install components such as a mount, rotor, hexagonal shaft, oscillator, ball bearings, linkage, and agitator. The mount comprises two receptacles for installing two ball bearings. The rotor and oscillator are rotatably secured to the ball bearings and connected by a link that actuates on a plane perpendicular to the axes of rotation. The hexagonal shaft is securely fixed on the rotor and the agitator is removably connected to the oscillator.

To operate, the clothes washing device is simply placed on top of a matching bucket and pushed down to be secured around the outer rim. Then an electric handheld drill is coupled to the hexagonal shaft of the clothes washing device onto its keyless chuck. The drill speed can now be set to a desired level by tying an adjustable loop around the trigger of the drill. A brushless and cordless electric handheld drill is the preferred choice since it generates less heat and often comes with overheating and overcurrent protection.

As the drill rotates the hexagonal shaft, rotary motion is converted to oscillatory motion by the link moving back and forth through its range of linear motion. The oscillatory motion is transmitted to the agitator and washes clothes in the bucket automatically. The operation can be stopped by loosening the adjustable loop.

The proposed clothes washing device outperforms the competition in terms of washing performance while still being cost-effective, light-weight and portable. The improved performance is achieved using a standalone electric handheld drill instead of a built-in motor and, in turn, stronger agitation can be generated by a more robust mechanical system of the drill. The manufacturing cost is therefore significantly reduced by eliminating the electrical and electronic components. Also, a standardized hexagonal shaft is used to achieve the highest compatibility with commonly used handheld drills.

### BRIEF DESCRIPTION OF THE DRAWINGS

In an aspect described herein, a clothes washing device 47 is disclosed in FIG. 1-29. Below accompanying drawings of the embodiment make further instructions for assembling the proposed clothes washing device 47.

FIG. 1 illustrates a perspective view of the clothes washing device 47.

FIG. 2 illustrates a perspective view of the clothes washing device 47 placed on a bucket 48 with a handheld drill 49, adjustable loop 43 and foam support 42 installed.

FIG. 3 shows a bucket lid with first opening 2, second opening 3 and view opening 45.

FIGS. 4 and 5 display perspective views of a mount 4.

FIGS. 6 and 7 illustrate before and after assembly views of the bucket lid 1, mount 4 and ball bearings 14, 15.

FIGS. 8 and 9 display perspective views of a rotor 16.

FIG. 10 and 11 display perspective views of an oscillator 21.

FIG. 12 is an exploded view of a hexagonal shaft 33, rotor 16, link 30, oscillator 21 and two sets of fasteners (pin 34, R-shaped clip 35, washer 36) before assembly.

FIG. 13 is an underside perspective view of FIG. 12 after assembly.

FIG. 14 is a perspective view of a link 30.

FIGS. 15 and 16 display perspective views of a flanged retainer 26.

FIGS. 17 and 18 display perspective views of a flanged cap 28.

FIG. 19 is a perspective view of the sub-assemblies from FIG. 7 and FIG. 13 aligned for assembly with the flanged retainer 26 and flanged cap 28.

FIG. 20 and FIG. 21 are perspective views of FIG. 19 after assembly.

FIGS. 22 and 23 illustrate before and after assembly views of an upper agitator 39, agitator rod 38 and lower agitator 40.

FIG. 24 shows the sub-assemblies from FIG. 21 and FIG. 23 coming together.

FIG. 25 illustrates an underside perspective view of the clothes washing device 47 with a housing 52 and foam support mount 37 installed.

FIG. 26 displays a front view of the clothes washing device 47 placed on a bucket 48 with the handheld drill 49 and foam support 42 mounted with the main components encircled 44.

FIG. 27 is a top view of the illustration displayed in FIG. 26.

FIG. 28 is a cross-section view of main components encircled 44 in FIG. 26 taken along the line 28-28 in FIG. 27.

FIG. 29 illustrates the linkage mechanism of the clothes washing device 47.

| | |
|---|---|
| 1 | Bucket lid |
| 2 | First opening |
| 3 | Second opening |
| 4 | Mount |
| 5 | Access aperture |
| 6 | First receptacle |
| 7 | Second receptacle |
| 8 | First receptacle aperture |
| 9 | Second receptacle aperture |
| 10 | Plate |
| 11 | First plate end |
| 12 | Second plate end |
| 13 | Half cylindrical shell |
| 14 | First ball bearing |
| 15 | Second ball bearing |
| 16 | Rotor |
| 17 | Rotor tubing |
| 18 | Hexagonal tunnel |
| 19 | Rotor flange |
| 20 | Rotor flange aperture |
| 21 | Oscillator |
| 22 | Oscillator tubing |
| 23 | Oscillator flange |
| 24 | Oscillator flange aperture |
| 25 | Oscillation angle |
| 26 | Flanged retainer |
| 27 | Flanged retainer tubing |
| 28 | Flanged cap |
| 29 | Flanged cap tubing |
| 30 | Link |
| 31 | First link aperture |
| 32 | Second link aperture |
| 33 | Hexagonal shaft |
| 34 | Pin |
| 35 | R-shaped Clip |
| 36 | Washer |
| 37 | Foam support mount |
| 38 | Agitator Rod |
| 39 | Upper agitator |
| 40 | Lower agitator |
| 41 | Trigger |
| 42 | Foam support |
| 43 | Adjustable loop |
| 44 | Main components encircled |
| 45 | View opening |
| 46 | Keyless chuck |
| 47 | Clothes washing device |
| 48 | Bucket |
| 49 | Handheld drill |
| 50 | Rotor distance |
| 51 | View opening distance |
| 52 | Housing |
| 53 | Rotor's axis of rotation |
| 54 | Oscillator's axis of rotation |
| 55 | First axis |
| 56 | Second axis |
| 57 | First reference line |
| 58 | Second reference line |

### DETAILED DESCRIPTION

### Introduction

Throughout this specification, unless otherwise specified or the context requires otherwise, the words “comprise” and “include” and variations such as “comprising,” “including,” and “having,” will be understood to imply the inclusion of an item or group of items, but not the exclusion of any other item or group of items.

Although the disclosed idea is described in connection with a specific embodiment, it should be understood that what is claimed should not be unduly limited to such embodiment. Those skilled in the art who review this disclosure will readily realize that numerous modifications are possible (e.g., variations in sizes, dimensions, structures, shapes and proportions of the various elements, values of parameters, mounting arrangements, use of materials, orientations, etc.) within the scope of the implementation as defined in the appended claims.

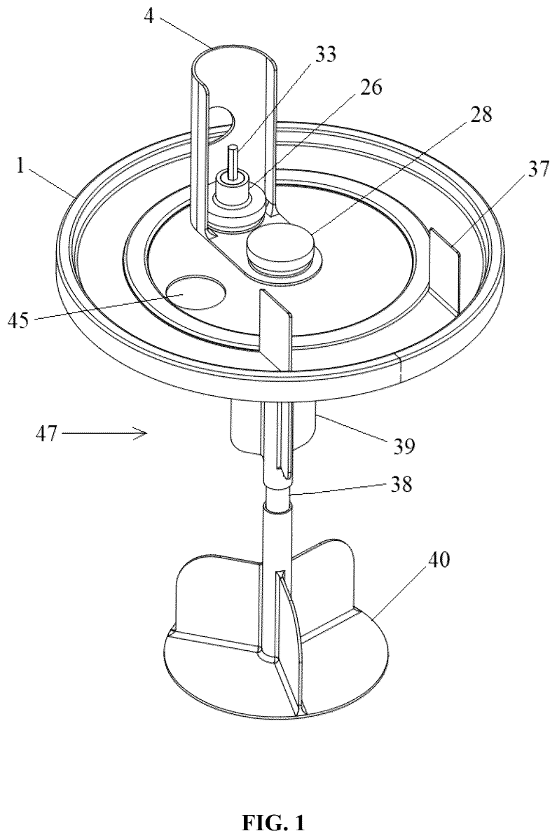

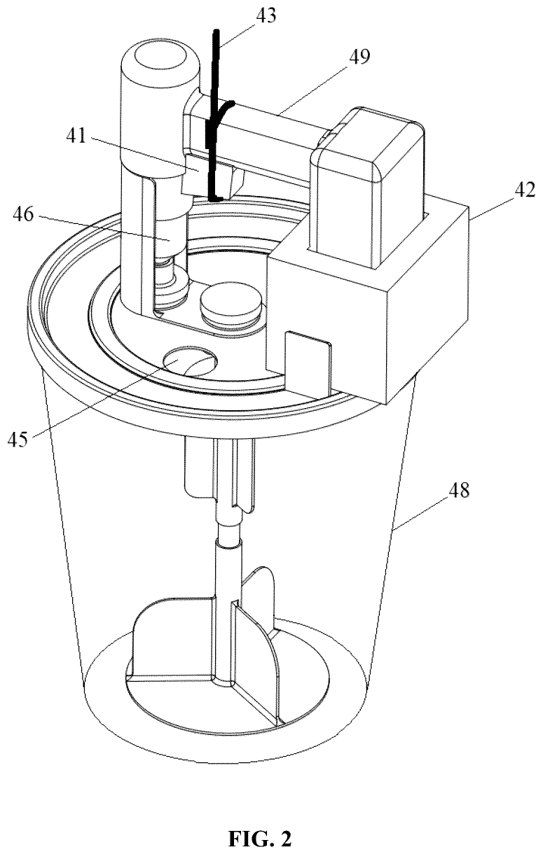

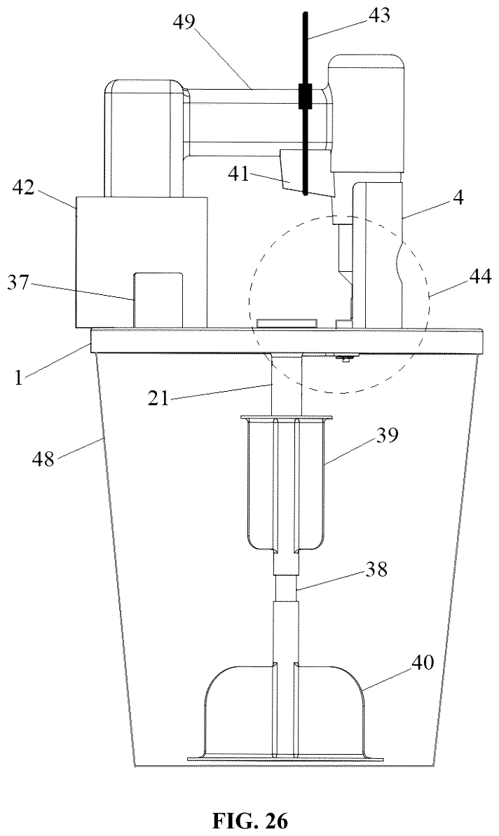

Referring now to the drawings FIG. 1-29 where a clothes washing device 47 is described. FIG. 1 shows the clothes washing device 47 before being set up for use. FIGS. 2 and 26 illustrate the clothes washing device 47 placed on a bucket 48 with a handheld drill 49, adjustable loop 43 and foam support 42 installed. The adjustable loop 43 wraps around the trigger 41 of the handheld drill 49 to keep it running continuously during operation. The foam support 42 works as a cradle with a pocket that has been cut out to match the shape of the battery to hold still during operation.

There are numerous ways of keeping the handheld drill 49 steady during operation such as using various types of quick release clamps and custom-designed rubber mounts. What is depicted herein should not limit the possible variations that can accomplish the same goal by different means.

### How the Device is Made

The clothes washing device 47 utilizes a commercially available bucket lid 1 for low cost of manufacturing, although a custom-designed bucket lid would be an option. The advantage of using a custom-designed bucket lid is being able to integrate some main components as part of the bucket lid 1 and therefore simplifying the assembly process. If a commercially available bucket lid 1 is used, two circular openings of the same size and an additional opening need to be cut out using hole saws.

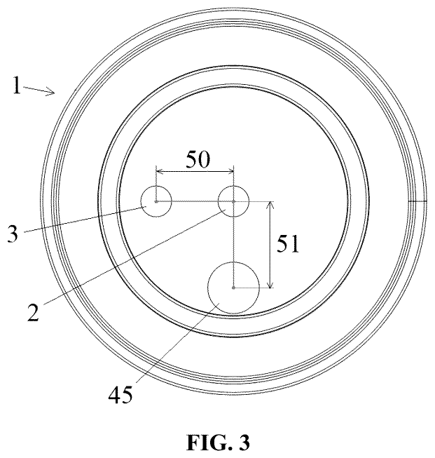

FIG. 3 shows the three openings that have been cut out to accommodate the assembly of the clothes washing device 47. A first opening 2 is located at the center of the bucket lid 1 and a second opening 3 is spaced apart from the center by a rotor distance 50 which is the same distance between the center points of the receptacles found on the mount 4. A view opening 45 is used for viewing under the bucket lid 1. As long as the structural rigidity of the bucket lid 1 is not compromised, the view opening distance 51 and diameter of the view opening 45 can be adjusted. A clear acrylic disc can be installed over the view opening 45 to prevent water from splashing out.

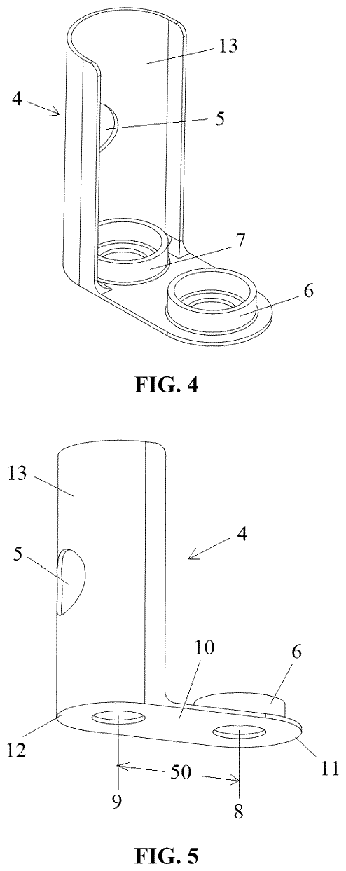

The next component needed is a mount 4 shown in FIGS. 4 and 5 that comprises a plate 10 with rounded edges that symmetrically further comprises two identical receptacles. Each receptacle is a cylindrical shell projecting from the plate 10 with an inner wall diameter slightly larger than the outer diameter of ball bearings 14, 15 to be described in later paragraphs. Each receptacle further comprises a concentric aperture. The receptacles and their concentric apertures are designated as first receptacle 6, second receptacle 7, first receptacle aperture 8 and second receptacle aperture 9.

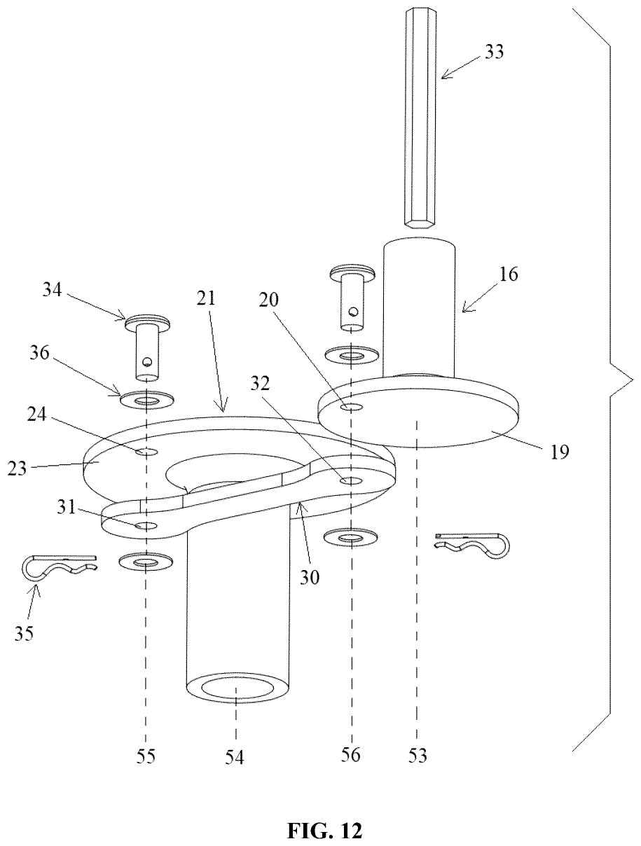

The mount 4 further comprises a half cylindrical shell 13 projected from the second plate end along the edge being concentric with the second receptacle 7. The half cylindrical shell 13 further comprises an aperture (access aperture 5) perpendicular to the second receptacle's longitudinal axis which is the same as the rotor's axis of rotation 53. (See FIG. 12) The access aperture 5 of the half cylindrical shell provides a passage way to the handheld drill's keyless chuck 46 for adjustment.

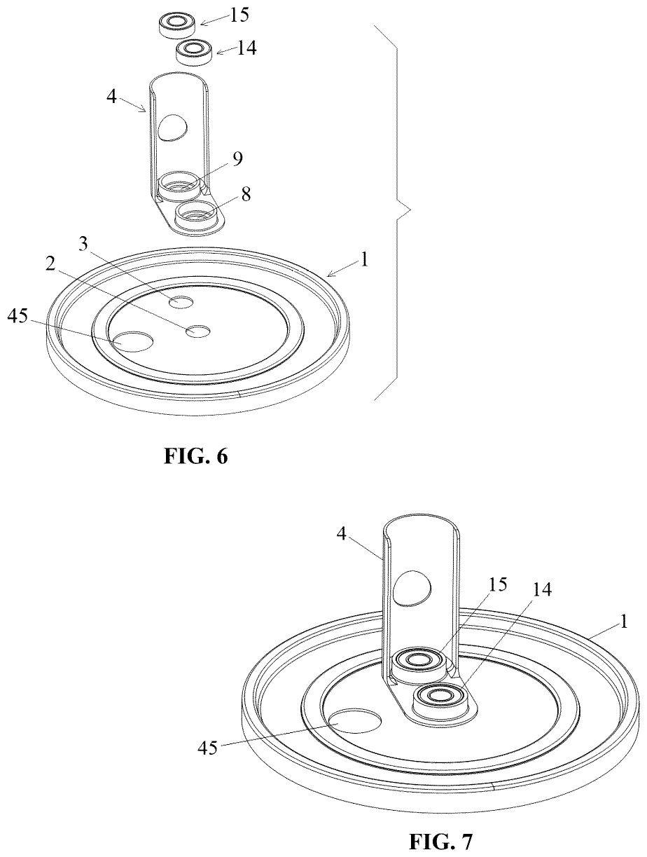

First subassembly includes the bucket lid 1, mount 4, first ball bearing 14 and second ball bearing 15 aligned for assembly as shown in FIG. 6. The first receptacle aperture 8 is aligned with the first opening 2 and the second receptacle aperture 9 is aligned with the second opening 3 of the bucket lid 1 for the first subassembly. Once the mount 4 is securely installed using fasteners or glued on, the first ball bearing 14 and second ball bearing 15 can be installed simply by pushing them into the receptacles. The ideal fit would hold the ball bearings in the receptacles tightly without using any glue, but can be glued as needed. The ball bearings and fasteners used are all standardized and commercially available parts. FIG. 7 shows a perspective view of the first subassembly.

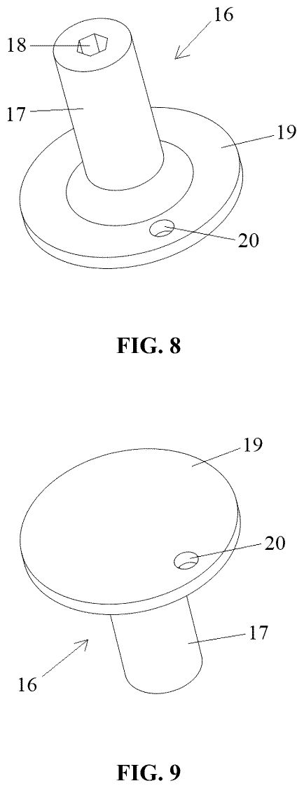

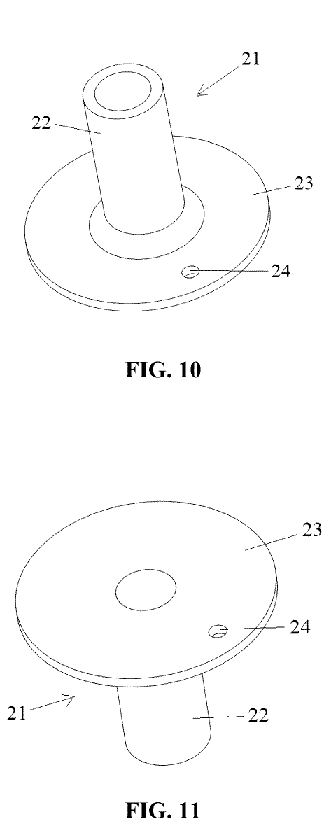

Second subassembly is a linkage system that includes a rotor 16, oscillator 21, link 30, hexagonal shaft 33 and two sets of fasteners aligned for assembly as shown in FIG. 12. One set of fasteners includes one pin 34 (Clevis type), two washers 36 and one R-shaped clip 35. FIGS. 8 and 9 display the rotor 16 having a closed flange (rotor flange 19) and tubing (rotor tubing 17) with a hexagonal tunnel 18 that fits a hexagonal shaft 33 with a tight fit. FIGS. 10 and 11 display the oscillator 21 having an open flange (oscillator flange 23) and tubing (oscillator tubing 22).

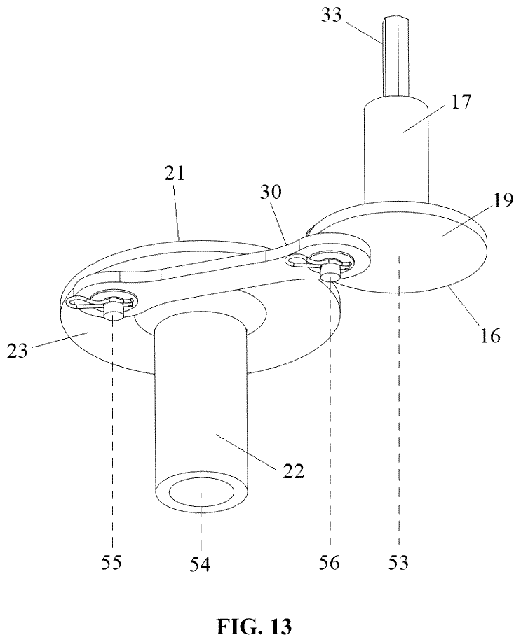

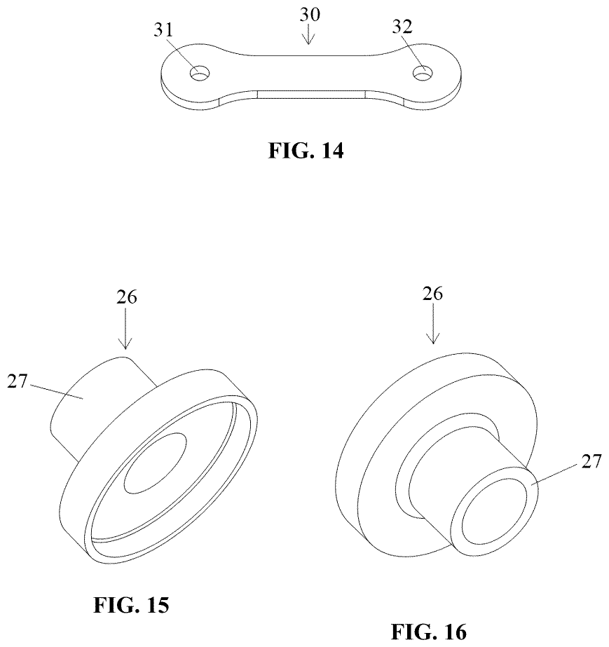

The rotor flange 19 further comprises an aperture (rotor flange aperture 20) closer to the outer rim. The oscillator flange 23 further comprises an aperture (oscillator flange aperture 24) closer to the outer rim. FIG. 14 shows the link 30 with two identical apertures (first link aperture 31 and second link aperture 32) in symmetry at each end. The apertures mentioned in this paragraph all have the same diameter, just large enough to fit the pin 34 with little to no friction without being wobbly. FIG. 13 shows an underside perspective view of the linkage system assembly.

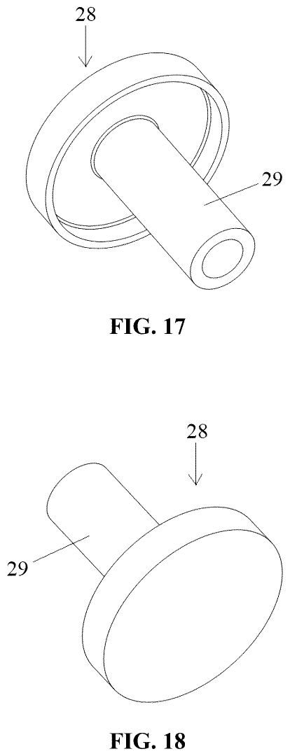

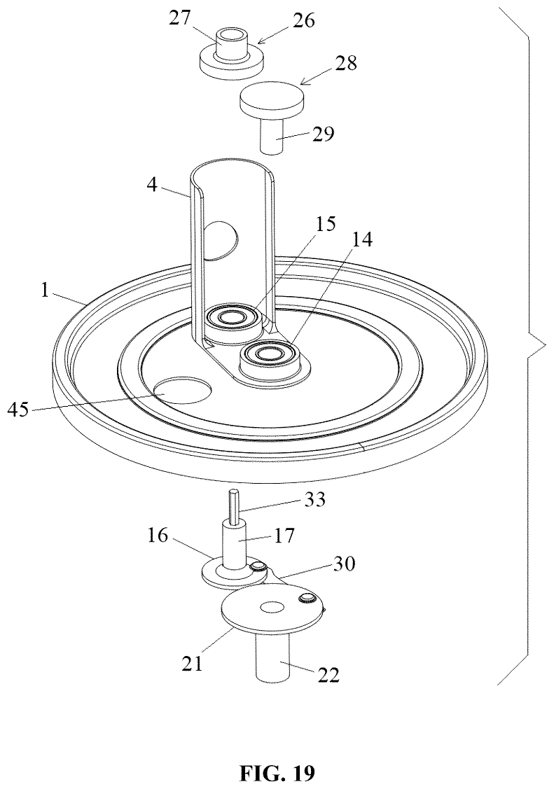

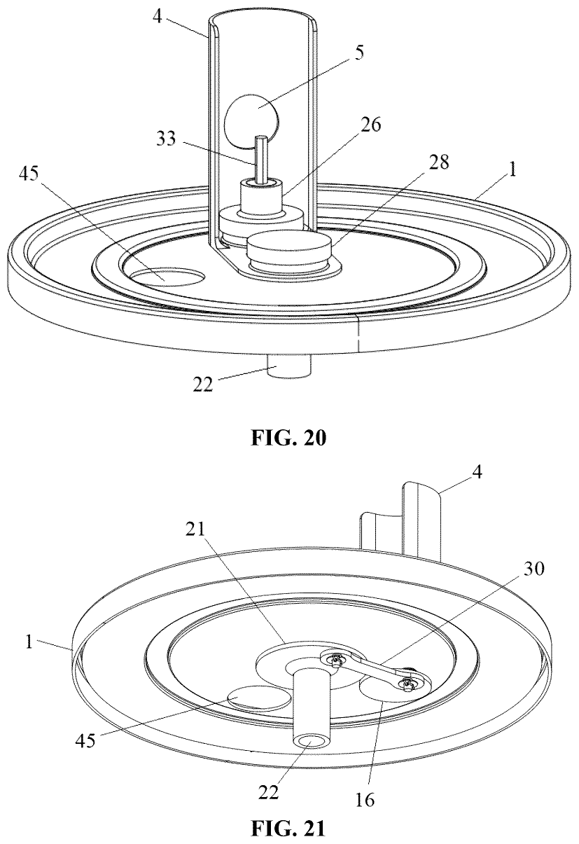

FIG. 19 illustrates the first and second subassemblies being aligned with a flanged retainer 26 and flanged cap 28 for assembly. The flanged retainer 26 is shown in FIGS. 15 and 16. The flanged cap 28 is shown in FIGS. 17 and 18. To assemble, rotor tubing 17 is inserted into the second ball bearing 15 from the underside of the bucket lid 1 tightly, then into the flanged retainer tubing 27. The flanged cap tubing 29 is inserted into the first ball bearing 14 from the topside of the bucket lid 1 tightly, then into the oscillator tubing 22. The flanged retainer 26 and flanged cap 28 are fixed in place by set screws or glued in. FIGS. 20 and 21 show perspective views of the assembly.

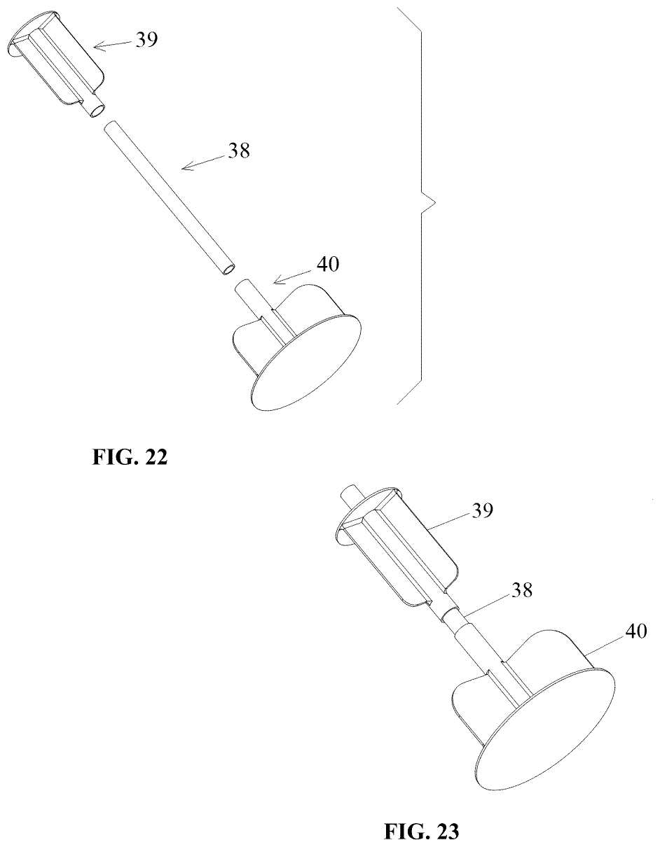

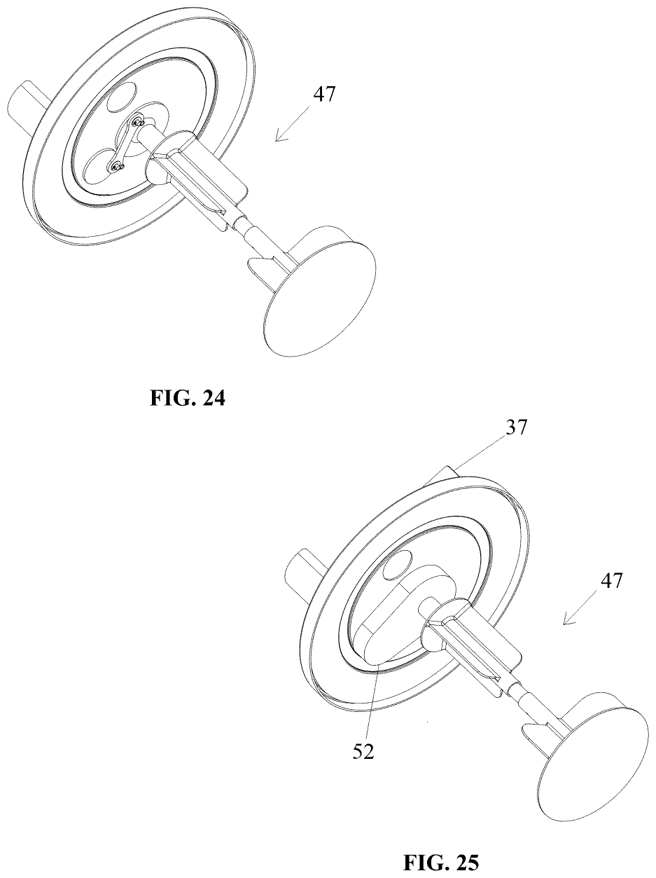

Third subassembly includes an upper agitator 39, agitator rod 38, and lower agitator 40 as illustrated before and after being assembled in FIGS. 22 and 23, respectively. FIG. 24 illustrates the assembly after the protruding portion of the agitator rod 38 of the third subassembly shown in FIG. 23 has been inserted into the oscillator tubing 22 shown in FIG. 21. FIG. 25 shows the clothes washing device 47 with a housing 52 for the linkage system and a foam support mount 37 installed. The agitator subassembly can be fixed in place by a quick release locking pin for easy disassembly and storage. Agitator design can come in different variations and not meant to impose any design constraints over the clothes washing device 47.

### How the Device Works

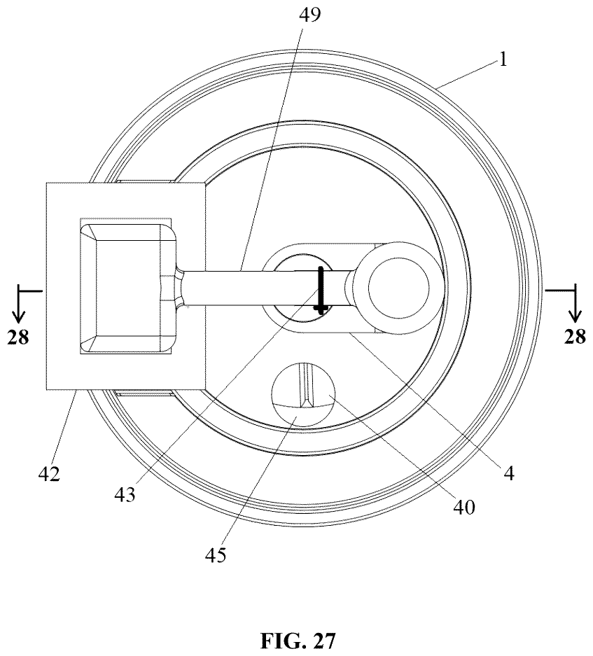

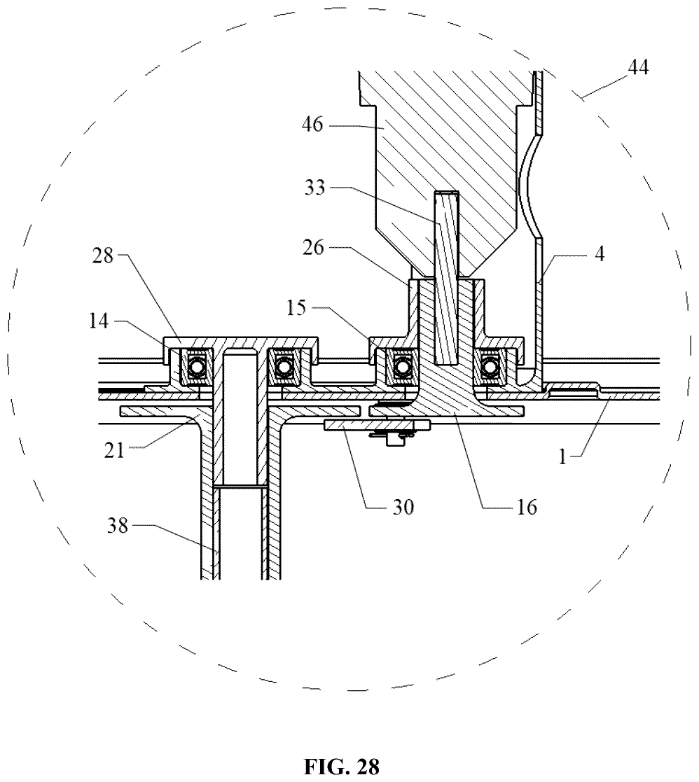

Before discussing the mechanism of the clothes washing device 47, it is beneficial to take a look at the interconnections of the main components. FIG. 28 shows a cross-section view of main components encircled 44 from FIG. 26 taken along the line 28-28 indicated in FIG. 27. The interconnections between the main components can be identified based on different hash lines.

During operation as the hexagonal shaft 33 is driven by the handheld drill 49, the attached rotor 16 can rotate freely along the rotor's axis of rotation 53. The rotational axes are identified in FIGS. 12 and 13. The rotation of the rotor 16 moves the link 30 back and forth since the link 30 is rotatably coupled to the oscillator flange 23 and the rotor flange 19 via apertures at each end. The first linkage aperture 31 is coupled to the oscillator flange aperture 24 along the first axis 55 and the second linkage aperture 32 is coupled to the rotor flange aperture 20 along the second axis 56. This arrangement sets the oscillator 21 into an oscillatory motion along the oscillator's axis of rotation 54. This oscillatory motion is transmitted to the attached agitator assembly (See FIGS. 21, 23 and 25) that comprises the agitator rod 38, upper agitator 39 and lower agitator 40 to wash clothes.

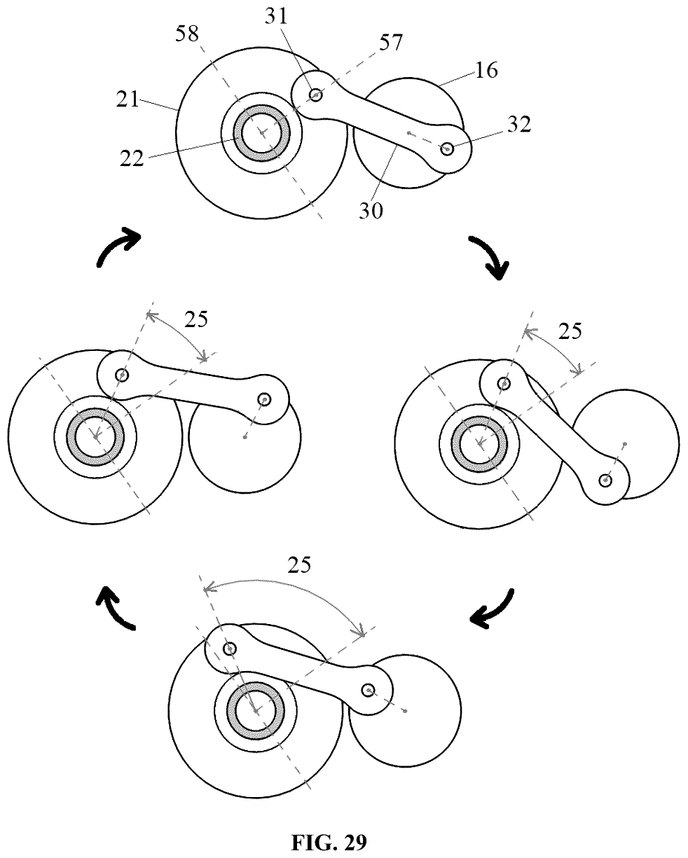

The mechanism of the clothes washing device 47 can be understood in further detail based on the illustration displayed in FIG. 29. During operation, the rotor 16 rotates freely with 360 degrees of freedom in both clockwise and counterclockwise directions whereas the oscillator 21 rotates at an oscillation angle 25 that stays within a 90 degrees reference limit set by a first reference line 57 and second reference line 58 that are perpendicular to each other.

This mechanism is made possible by having the rotor's diameter less than the oscillator's diameter. As a result, the second link aperture 32 coupled to the rotor flange aperture 20 rotates in a smaller circle in comparison to the first link aperture 31 coupled to the oscillator flange aperture 24. The length of the link 30 is also critical in limiting the oscillator 21 to rotate within the oscillation angle 25 while preventing the link 30 from crashing into the oscillator tubing 22.

### How to use the Device

Follow below steps to use the device. Operation time may depend on the load and may be extended based on results and trials.
1) Fill a bucket 48 with water, detergent and soiled clothes. Water level should be according to the load with the maximum level just below the housing 52.
2) Place the clothes washing device 47 on top of the bucket 48 and push down to close tightly.
3) Wipe off any water on top of the bucket lid 1.
4) Insert the hexagonal shaft 33 onto the keyless chuck 46 of an electric handheld drill 49 (preferably brushless and cordless) and tighten securely. (See FIG. 2.)
5) Use a foam support 42 to keep the battery end of the electric handheld drill 49 in place.
6) Slowly pull the trigger 41 of the electric handheld drill 49 and check if the agitator assembly oscillates properly through the viewing window 45.
7) In order to keep the trigger 41 pressed, tie an adjustable loop 43 (e.g. adjustable zip tie or Velcro strip) around the trigger 41 of the electric handheld drill 49.
8) Adjust the speed of the electric handheld drill 49 by tightening or loosening the adjustable loop 43. FIGS. 2 and 26 illustrate the complete setup.
9) Allow 5 to 10 minutes of wash cycle depending on the load and stop the operation by loosening the loop 43.
10) Stop the operation immediately and allow the electric handheld drill 49 to cool down whenever overheating is detected.

Note: Most brushless electric handheld drills have an auto-shutoff feature for protection against overcurrent and overheating conditions.

### CONCLUSIONS

The clothes washing device 47 comprises mostly simple plastic parts that are easy to model and injection mold. The bucket lid 1, ball bearings 14, 15 and fasteners (pin 34, R-shaped clip 35, washer 36) are all commercial-off-the-shelf items that are widely available at a very low cost. A custom-designed bucket lid at extra cost can be made with integrated mounts to simplify the manufacturing process. However, it would be recommended to use commercially available bucket lids to assess the consumer demand for the product before committing to investing in a custom-designed bucket lid.

The main advantage of the clothes washing device 47 over others is that a standalone electric handheld drill 49 is used to automate the washing process rather than a built-in motor. This not only saves manufacturing costs but greatly improves the reliability and availability of the clothes washing device 47. Commonly available electric handheld drills are more robust and reliable than portable clothes washing devices with built-in motors that usually are subjected to less stringent requirements. Simplifying the system design with only mechanical parts serves to increase the product lifespan greatly.

The above description is given by way of an example not limited to what's being disclosed. Given the above disclosure, one skilled in the art could devise variations that are within the scope and spirit of the disclosed embodiments herein. Further, the various features of the embodiments disclosed herein can be used alone, or in varying combinations with each other and are not intended to be limited to the specific combination described herein. Thus, the scope of the claims is not to be limited by the illustrated embodiments.

1. A clothes washing device comprising:
a bucket lid comprising a rim-receiving groove for attaching to a standardized bucket rim, wherein the bucket lid further comprises a first opening, second opening and third opening;
a mount comprising a plate, wherein the plate further comprises a first plate end, second plate end, first receptacle, second receptacle and half cylindrical shell;
a rotor comprising a closed flange and centrally protruded tubing, wherein the closed flange further comprises an aperture substantially closer to the annular edge and the tubing further comprises a hexagonal tunnel concentric to the rotational axis;
an oscillator comprising an open flange and centrally protruded tubing. wherein the open flange further comprises an aperture substantially closer to the annular edge;
a flanged retainer comprising an open flange and centrally protruded tubing;
a flanged cap comprising a closed flange and centrally protruded tubing;
a first ball bearing secured in the first receptacle of the mount;
a second ball bearing secured in the second receptacle of the mount;
a hexagonal shaft compatible with a keyless chuck of a commonly used handheld drill;
a shared link comprising an elongated plate with two identical apertures near each rounded end in a symmetry;
a linkage system having the shared link connected to the rotor and oscillator configured to convert a rotary motion into an oscillatory motion;
an adjustable loop comprising a flexible strip with a resettable locking mechanism for applying force on the trigger of the handheld drill at a constant speed;
an agitator that attaches to the tubing of the oscillator;

2. The clothes washing device in claim 1,
wherein the first opening is located at the center of the bucket lid, wherein the diameter of the first opening is marginally larger than the diameter of the oscillator's tubing:

3. The clothes washing device in claim 1,
wherein the second opening is located to be concentric to the rotor's axis of rotation,
wherein the diameter of the second opening is marginally larger than the diameter of the rotor's tubing;

4. The clothes washing device in claim 1,
wherein the third opening allows viewing under the bucket lid;

5. The clothes washing device in claim 1,
wherein the first receptacle and second receptacle of the mount are cylindrically shaped pockets identical in dimensions,
wherein the first receptacle and second receptacle each further comprises a concentric aperture,
wherein the diameter of the first receptacle aperture is slightly larger than the diameter of the oscillator's tubing and the diameter of the second receptacle aperture is slightly larger than the diameter of the rotor's tubing;

6. The clothes washing device in claim 1.
wherein the half cylindrical shell of the mount is projected from the second plate end along the edge,
wherein the half cylindrical shell further comprises an aperture perpendicular to the second receptacle's longitudinal axis;

7. The clothes washing device in claim 1,
wherein the mount is fixed on top of the bucket lid with the first receptacle's aperture aligned with the first opening of the bucket lid and the second receptacle's aperture aligned with the second opening of the bucket lid;

8. The clothes washing device in claim 1,
wherein the tubing of the flanged cap is secured in the hole of the first ball bearing and also secured inside the tubing of the oscillator as an assembled body;

9. The clothes washing device in claim 1,
wherein the tubing of the rotor is secured in the hole of the second ball bearing and also secured inside the tubing of the flanged retainer as an assembled body;

10. The clothes washing device in claim 1,
wherein the apertures on the shared link are configured and arranged for rotary movement about a first axis relative to the oscillator and a second axis relative to the rotor;

11. The clothes washing device in claim 1,
wherein the hexagonal shaft is securely held in the hexagonal tunnel of the rotor;

12. The clothes washing device in claim 1,
wherein the hexagonal shaft connects to the keyless chuck of the handheld drill during operation;

13. The clothes washing device in claim 1,
wherein a rotation of the hexagonal shaft by the handheld drill rotates the rotor with 360 degrees of freedom in clockwise and counterclockwise directions along the rotor's axis of rotation,
wherein the rotation of the rotor linearly moves the shared link back and forth on a plane perpendicular to the rotor's axis of rotation,
wherein the movement of the shared link rotates the oscillator with less than 90 degrees of freedom in clockwise and counterclockwise directions along the oscillator's axis of rotation,
wherein the agitator rotates along with the oscillator as an attachment;

14. The clothes washing device in claim 1,
wherein the half cylindrical shell of the mount abuts against the keyless chuck of the handheld drill and neighboring section to minimize movements during operation;

15. The clothes washing device in claim 1,
wherein the keyless chuck of the handheld drill mounted on the clothes washing device can be accessed through the aperture of the half cylindrical shell of the mount;

16. The clothes washing device in claim 1,
wherein a cradle on the bucket lid holds the handheld drill at the battery end to minimize movements during operation;
